(19) United States
(12) Patent Application Publication
(10) Pub. No.: US 2024/0051851 A1
(43) Pub. Date: Feb. 15, 2024

(54) METHODS AND SYSTEMS FOR USING ULTRAVIOLET LIGHT-EMITTING DIODES FOR DISINFECTION OF STATIONARY FLUIDS

(71) Applicant: Acuva Technologies Inc., Burnaby (CA)

(72) Inventors: Babak Adeli KOUDEHI, Burnaby (CA); Milad Raeiszadeh OSKOUEI, Vancouver (CA); Ehsan ESPID, Burnaby (CA); Peter ENNS, Surrey (CA)

(21) Appl. No.: 18/448,893

(22) Filed: Aug. 11, 2023

Related U.S. Application Data
(60) Provisional application No. 63/397,375, filed on Aug. 11, 2022.

(51) Int. Cl. C02F 1/32; C02F 1/00

(52) U.S. Cl. CPC C02F 1/325; C02F 1/002; C02F 2201/3222; C02F 2201/3221; C02F 2307/02

(57) ABSTRACT

An ultraviolet disinfectant head attachable to a fluid container having a central axis for disinfecting a fluid housed in a cavity of the fluid container. The system comprises an ultraviolet light emitting diode (UV-LED) having a principal emission axis and a lens (e.g. a diverging lens) having a primary optical axis. The lens is located and/or oriented to receive radiation from the UV-LED and direct refracted radiation toward the cavity of the fluid container. The refracted radiation may be diverging when it reaches a fill plane of the fluid container.

### RELATED APPLICATIONS

This application claims priority from U.S. application No. 63/397,375 filed on 11 Aug. 2022. For the purposes of the United States, this application claims the benefit under 35 USC 119 in relation to U.S. application No. 63/397,375 filed on 11 Aug. 2022 which is hereby incorporated herein by reference.

### TECHNICAL FIELD

This invention relates generally to disinfection devices, and in particular to disinfection devices which include one or more ultraviolet (UV) radiation emitters configured to direct UV radiation into a vessel which may contain stationary (non-flowing) fluid. Particular embodiments have example applications for disinfecting water stored in water-storage containers, including, without limitation, drinking water-storage containers for personal use.

### BACKGROUND

UV radiation, such as that emitted by ultraviolet light emitting diodes (UV-LEDs) is known to be effective in neutralizing germs such as bacteria, viruses and fungi by dam aging the DNA of the germs such that they become incapable of reproducing.

There is a general desire to use UV-LEDs to disinfect stationary (non-flowing) fluids (e.g. water) stored in storage (e.g. water storage) containers, including, without limitation, drinking water-storage containers for personal use.

In some cases, such water-storage containers have dimensional restrictions. For example, because it is desirable to store drinking water in a refrigerator, the height of the water-storage container may be restricted since such a drinking water container may be required to fit between the shelves of a refrigerator. There is a general desire for apparatus and methods for using UV-LEDs to disinfect stationary (non-flowing) fluids (e.g. water) which permit storage of a maximal amount of fluids (e.g. for a given set of dimensional restrictions), while providing a suitable amount and distribution of radiation fluence for disinfecting the stored fluid.

In some cases, water-storage containers may also incorporate physical filter systems, which may limit the options for placement of UV-LEDs used for disinfection since such a physical filter system may occlude radiation from such UV-LEDs from reaching the water held in the container.

There is a desire to provide disinfection apparatus for stationary (non-flowing) fluids (e.g. water) stored in storage (e.g. water storage) containers which are energy efficient—e.g. which use a relatively large proportion of their input energy to generate radiation that actually plays a part in disinfecting the stored fluids. Where a UV emitter is not situated ideally, UV radiation may not be used efficiently. For example, UV radiation from non-ideally located UV-LEDs may be lost to the walls of the fluid-storage container and/or to physical filtration components which may block some of the radiation. There is a general desire to mitigate the loss of radiation to the walls or other components of the disinfection apparatus to thereby increase energy efficiency for use in disinfection.

There is a general desire to disinfect stationary (non-flowing) fluids (e.g. water) stored in storage (e.g. water storage) containers with a distribution and power of UV radiation that is sufficient to effect the disinfection of all or substantially all of the volume of fluid stored in the container. For example, it might be desirable to disinfect over some threshold amount (e.g. 99%) of pathogens in some threshold percentage (e.g. 99%) of the volume of cavity of the container.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an ultraviolet disinfectant head for disinfecting a fluid housed in a cavity of a fluid container having a central axis. The ultraviolet disinfectant head may comprise an ultraviolet light emitting diode (UV-LED) having a principal emission axis and a lens having a primary optical axis, the lens oriented and/or located to receive radiation from the UV-LED and direct refracted radiation toward a fill plane of the cavity of the fluid container.

In some embodiments, the lens is a diverging lens. In some embodiments, that the refracted radiation is diverging when it reaches the fill plane of the fluid container.

In some embodiments, when the ultraviolet disinfectant head is attached to the fluid container, the principal emission axis of the UV-LED is co-axial with the central axis of the fluid container and the principal emission axis of the UV-LED is co-axial with the primary optical axis of the lens.

In some embodiments, the principal emission axis of the UV-LED is spaced apart from and parallel to the central axis of the fluid container when the ultraviolet disinfectant head is attached to the fluid container. In some embodiments, the principal emission axis of the UV-LED is co-axial to the primary optical axis of the lens. In some embodiments, the principal emission axis of the UV-LED is spaced apart from and parallel to the primary optical axis of the lens. In some embodiments, the principal emission axis of the UV-LED is oriented at a first angle relative to the primary optical axis of the lens and the first angle is an acute angle.

In some embodiments, the UV-LED is spaced apart from the central axis of the fluid container and the principal emission axis of the UV-LED is non-parallel to the central axis of the fluid container when the ultraviolet disinfectant head is attached to the fluid container. In some embodiments, the principal emission axis of the UV-LED is co-axial to the primary optical axis of the lens. In some embodiments, the principal emission axis of the UV-LED is spaced apart from and parallel to the primary optical axis of the lens. In some embodiments, the primary optical axis of the lens is spaced apart from and parallel to the central axis of the fluid container. In some embodiments, the principal emission axis of the UV-LED is oriented at a second angle relative to the primary optical axis of the lens and the second angle is an acute angle.

In some embodiments, the UV-LED is spaced apart from the central axis of the fluid container and the principal emission axis of the UV-LED is oriented at a third angle relative to the central axis of the fluid container when the ultraviolet disinfectant head is attached to the fluid container and the third angle is an acute angle. In some embodiments, the principal emission axis of the UV-LED is co-axial to the primary optical axis of the lens. In some embodiments, the principal emission axis of the UV-LED is spaced apart from and parallel to the primary optical axis of the lens. In some embodiments, the primary optical axis of the lens is spaced apart from and parallel to the central axis of the fluid container. In some embodiments, the principal emission axis of the UV-LED is oriented at a fourth angle relative to the primary optical axis of the lens and the fourth angle is an acute angle.

In some embodiments, the ultraviolet disinfectant head comprises a filter for filtering fluid that passes through the ultraviolet disinfectant head into or out of the fluid container. In some embodiments, the central axis of the fluid container intersects the filter when the ultraviolet disinfectant head is attached to the fluid container.

In some embodiments, the ultraviolet disinfectant head is part of a lid of the fluid container. In some embodiments, the ultraviolet disinfectant head is attachable to a mouth of the fluid container. In some embodiments, the ultraviolet disinfectant head is attachable to the fluid container between a mouth of the fluid container and a lid of the fluid container.

In some embodiments, the lens is an asymmetric diverging lens. In some embodiments, the lens is an asymmetric diverging lens wherein the asymmetric diverging lens is asymmetric about a central axis of the asymmetric diverging lens. In some embodiments, the lens is a concave lens. In some embodiments, the lens is a biconcave lens. In some embodiments, the lens is a plano-concave lens. In some embodiments, the lens is a negative meniscus lens.

In some embodiments, the ultraviolet disinfectant head comprises a second UV-LED and the lens is oriented and/or located to receive second radiation from the second UV-LED and direct second refracted radiation toward the cavity of the fluid container. In some embodiments, the ultraviolet disinfectant head comprises a second lens and the lens and the second lens are together oriented and/or located to receive the radiation from the UV-LED and direct the refracted radiation toward the cavity of the fluid container.

In some embodiments, the ultraviolet disinfectant head comprises a battery to power the UV-LED.

In some embodiments, the ultraviolet disinfectant head comprises a controller configured to control drive current provided to the UV-LED.

In some embodiments, the ultraviolet disinfectant head comprises a temperature sensor for measuring the temperature of the UV-LED and wherein the controller is configured to control the drive current provided to the UV-LED based at least in part on the temperature of the UV-LED.

In some embodiments, the controller is configured to control the drive current provided to the UV-LED based at least in part on a period of time since the drive current was provided to the UV-LED.

In some embodiments, the ultraviolet disinfectant head comprises a fluid level sensor for determining a level of fluid in the cavity of the fluid container and wherein the controller is configured to control the drive current provided to the UV-LED based at least in part on the level of fluid within the cavity of the fluid container.

In some embodiments, the ultraviolet disinfectant head comprises a flow sensor for determining a rate at which fluid is entering the cavity of the fluid container and wherein the controller is configured to control the drive current provided to the UV-LED based at least in part on the rate at which fluid is entering the cavity of the fluid container.

In some embodiments, the ultraviolet disinfectant head comprises a UV transmittance sensor for determining a UV transmittance of the fluid in the cavity of the fluid container and wherein the controller is configured to control the drive current provided to the UV-LED based at least in part on the UV transmittance of the fluid in the cavity of the fluid container.

In some embodiments, the ultraviolet disinfectant head comprises a heat sink in thermal contact with the UV-LED for cooling of the UV-LED.

Another aspect of the invention provides a method for treating fluid contained in a cavity of a fluid container having a central axis. The method may comprise attaching an ultraviolet disinfectant head to the fluid container. The ultraviolet disinfectant head may comprise an ultraviolet light emitting diode (UV-LED) having a principal emission axis and a lens having a primary optical axis. The method may comprise emitting radiation from the UV-LED and refracting the radiation through the lens to direct refracted radiation toward the cavity of the fluid container. In some embodiments, the lens is a diverging lens. In some embodiments, the refracted radiation is diverging when it reaches a fill plane of the fluid container

In some embodiments, when the ultraviolet disinfectant head is attached to the fluid container, the principal emission axis of the UV-LED is co-axial with the central axis of the fluid container and the principal emission axis of the UV-LED is co-axial with the primary optical axis of the lens.

In some embodiments, the principal emission axis of the UV-LED is spaced apart from and parallel to the central axis of the fluid container when the ultraviolet disinfectant head is attached to the fluid container. In some embodiments, the principal emission axis of the UV-LED is co-axial to the primary optical axis of the lens. In some embodiments, the principal emission axis of the UV-LED is spaced apart from and parallel to the primary optical axis of the lens. In some embodiments, the principal emission axis of the UV-LED is oriented at a first angle relative to the primary optical axis of the lens and the first angle is an acute angle.

In some embodiments, the UV-LED is spaced apart from the central axis of the fluid container and the principal emission axis of the UV-LED is non-parallel to the central axis of the fluid container when the ultraviolet disinfectant head is attached to the fluid container. In some embodiments, the principal emission axis of the UV-LED is co-axial to the primary optical axis of the lens. In some embodiments, the principal emission axis of the UV-LED is spaced apart from and parallel to the primary optical axis of the lens. In some embodiments, the primary optical axis of the lens is spaced apart from and parallel to the central axis of the fluid container. In some embodiments, the principal emission axis of the UV-LED is oriented at a second angle relative to the primary optical axis of the lens and the second angle is an acute angle.

In some embodiments, the UV-LED is spaced apart from the central axis of the fluid container and the principal emission axis of the UV-LED is oriented at a third angle relative to the central axis of the fluid container when the ultraviolet disinfectant head is attached to the fluid container and the third angle is an acute angle. In some embodiments, the principal emission axis of the UV-LED is co-axial to the primary optical axis of the lens. In some embodiments, the principal emission axis of the UV-LED is spaced apart from and parallel to the primary optical axis of the lens. In some embodiments, the primary optical axis of the lens is spaced apart from and parallel to the central axis of the fluid container. In some embodiments, the principal emission axis of the UV-LED is oriented at a fourth angle relative to the primary optical axis of the lens and the fourth angle is an acute angle.

In some embodiments, the ultraviolet disinfectant head comprises a filter for filtering fluid that passes through the ultraviolet disinfectant head into or out of the fluid container. In some embodiments, the central axis of the fluid container intersects the filter when the ultraviolet disinfectant head is attached to the fluid container.

In some embodiments, the ultraviolet disinfectant head is part of a lid of the fluid container. In some embodiments, the ultraviolet disinfectant head is attachable to a mouth of the fluid container. In some embodiments, the ultraviolet disinfectant head is attachable to the fluid container between a mouth of the fluid container and a lid of the fluid container.

In some embodiments, the lens is an asymmetric diverging lens. In some embodiments, the lens is an asymmetric diverging lens wherein the asymmetric diverging lens is asymmetric about a central axis of the asymmetric diverging lens. In some embodiments, the lens is a concave lens. In some embodiments, the lens is a biconcave lens. In some embodiments, the lens is a plano-concave lens. In some embodiments, the lens is a negative meniscus lens.

In some embodiments, the ultraviolet disinfectant head comprises a second UV-LED and the lens is oriented and/or located to receive second radiation from the second UV-LED and direct second refracted radiation toward the cavity of the fluid container. In some embodiments, the ultraviolet disinfectant head comprises a second lens and the lens and the second lens are together oriented and/or located to receive the radiation from the UV-LED and direct the refracted radiation toward the cavity of the fluid container.

In some embodiments, the ultraviolet disinfectant head comprises a battery to power the UV-LED.

In some embodiments, the method comprises controlling a drive current provided to the UV-LED based at least in part on a temperature of the UV-LED.

In some embodiments, the method comprises controlling a drive current provided to the UV-LED based at least in part on a period of time since the drive current was provided to the UV-LED.

In some embodiments, the method comprises controlling a drive current provided to the UV-LED based at least in part on a level of fluid within the cavity of the fluid container.

In some embodiments, the method comprises controlling a drive current provided to the UV-LED based at least in part on a rate at which fluid is entering the cavity of the fluid container.

In some embodiments, the method comprises controlling a drive current provided to the UV-LED based at least in part on a UV transmittance of the fluid in the cavity of the fluid container.

Other aspects of the invention provide apparatus comprising any new and inventive feature, combination of features, or sub-combination of features described herein.

Other aspects of the invention provide methods comprising any new and inventive feature, combination of features or sub-combination of features described herein.

It is emphasized that the invention relates to all combinations of the above features, even if these are recited in different claims.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic side cross-sectional view of a fluid container comprising a disinfectant head according to an embodiment of the invention.

FIG. 2 is a schematic side cross-sectional view of a fluid container comprising another disinfectant head according to an embodiment of the invention.

FIG. 3 is a schematic side cross-sectional view of a fluid container comprising another disinfectant head according to an embodiment of the invention.

FIG. 4 is a schematic side cross-sectional view of a fluid container comprising another disinfectant head according to an embodiment of the invention.

FIG. 5 is a schematic side cross-sectional view of a fluid container comprising another disinfectant head according to an embodiment of the invention.

FIG. 6 is a schematic side cross-sectional view of a fluid container comprising another disinfectant head according to an embodiment of the invention.

FIG. 7 is a schematic side cross-sectional view of a fluid container comprising another disinfectant head according to an embodiment of the invention.

FIG. 8 is a schematic side cross-sectional view of a fluid container comprising another disinfectant head according to an embodiment of the invention.

FIG. 9 is a schematic side cross-sectional view of a fluid container comprising another disinfectant head according to an embodiment of the invention.

FIG. 10 is a perspective view of a disinfectant head according to an embodiment of the invention.

FIG. 11 is a side cross-sectional view of a portion of the FIG. 10 disinfectant head.

FIG. 12 is an exploded view of a portion of the FIG. 10 disinfectant head.

FIG. 13A is schematic depiction of a diverging lens that may be employed with a disinfectant head according to an embodiment of the invention. FIG. 13B is schematic depiction of a diverging lens that may be employed with a disinfectant head according to an embodiment of the invention. FIG. 13C is schematic depiction of a diverging lens that may be employed with a disinfectant head according to an embodiment of the invention. FIG. 13D is schematic depiction of a diverging lens that may be employed with a disinfectant head according to an embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides an ultra violet (UV) disinfectant head for attaching to a fluid container.

The fluid container may be employed for storing any type of fluid. In some embodiments, the fluid container is employed to store water. In some embodiments, the fluid container comprises, for example, a water bottle (e.g. for personal use), a water storage tank (e.g. for medical, food, agricultural, commercial or industrial purposes).

The fluid container may define a cavity for receiving and storing a volume of fluid (e.g. water) below a fill plane (e.g. a nominal plane defining the limits of how much fluid can be stored within the cavity without overflowing and/or interfering with the UV disinfectant head and/or a lid of the fluid container). Fluid may enter the cavity through a mouth of the fluid container. A lid may be provided to seal or substantially seal the mouth of the fluid container thereby sealing or substantially sealing the fluid container.

In some embodiments, the UV disinfectant head is attachable to the mouth of the fluid container. In some embodiments, the UV disinfectant head may seal or substantially seal the mouth of the fluid container when attached to the mouth of the fluid container. In some embodiments, the UV disinfectant head may be integrated into or attachable to a lid of the fluid container. In some embodiments, the UV disinfectant head may be attachable to a mouth of the fluid container and a lid may be in turn attachable to the UV disinfectant head to seal or substantially seal the fluid container.

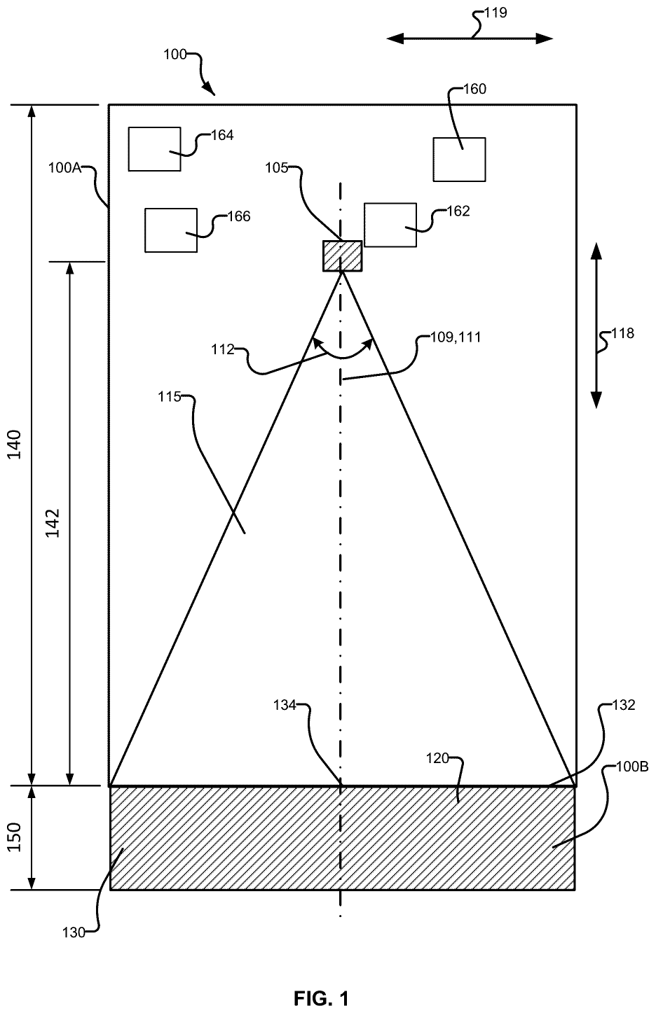

FIG. 1 depicts a fluid container system 100 comprising an ultra violet (UV) disinfectant head 100A and a fluid container 100B according to an embodiment of the invention. It should be understood that while FIG. 1 depicts both a disinfectant head 100A and a fluid container 100B, it should be understood that fluid container 100B is shown at least in part to facilitate description of disinfectant head 100A and disinfectant head 100A could be provided separately from fluid container 100B. Further, while fluid container system 100 is depicted as comprising only a single disinfectant head 100A, it should be understood that multiple disinfectant heads 100A could be provide for a single fluid container 100B (e.g. where fluid container 100B is a large fluid storage tank).

Container 100B defines a cavity 130 for fluid storage. Fluid container 100B may be, for example, a water bottle or water jug for storing water (e.g. drinking water) for personal use. It may be desirable to store such fluid containers 100B, in a refrigerator or the like, where the dimensions of such fluid containers 100B are limited. Where fluid container system 100 is designed for use in a refrigerator or other space-limited applications, the total height of fluid container system 100 may be limited (e.g. to the space between refrigerator shelves). In the FIG. 1 embodiment, the minimum total height of fluid container system 100 is the sum of the height 140 of UV disinfectant head 100A and the depth 150 of container 100B. It can be desirable that height 140 (of disinfectant head 100A) is as small as possible when compared to the total height of fluid container system 100 (the sum of height 140 and depth 150), so that the depth of cavity 130 is relatively large and, consequently, the amount of fluid 120 capable of being housed in cavity 130 is relatively large for the available dimensions of container 100.

Fluid 120 may be stored in cavity 130 up to a fill plane 132 (e.g. a nominal plane defining the limits of how much fluid can be stored within the cavity without overflowing and/or interfering with the UV disinfectant head 100A and/or a lid of the fluid container). It will be appreciated that a maximum total volume of fluid 120 stored in cavity 130 is generally proportional to (or correlated with) depth 150—that is, the greater depth 150, the greater the volume of fluid that can be housed in cavity 130. In the illustrated embodiment, UV-LED 105 is spaced apart from the fill plane 132 of cavity 130 in longitudinal direction 118 by a distance 142.

Disinfectant head 100A comprises one or more ultraviolet light emitting diodes (UV-LEDs) 105 positioned to irradiate fluid 120 housed in cavity 130 of fluid container 100B. For simplicity, UV-LED 105 is shown as a single UV-LED in the illustrated view, but it will be appreciated that UV-LED 105 may comprise multiple LED components (e.g. multiple UV-LEDs). UV-LED 105 may be powered by a battery (not shown) within disinfectant head 100A or external to disinfectant head 100A. UV-LED 105 may be powered by an external power source (e.g. an electrical outlet, a generator, a solar panel, etc.). In some embodiments, a heat sink may be provided in thermal contact with UV-LEDs 105 to assist with cooling of UV-LEDs.

UV-LED 105 emits UV radiation 115 which can disinfect fluid 120. In particular, UV-LED 105 emits radiation 115 having a principal emission axis 109 (i.e. an axis along which the intensity of emitted radiation of UV-LED 105 is maximal). In the FIG. 1 embodiment, UV-LED 105 may be arranged such that principal emission axis 109 of UV-LED may be parallel with (and, in the illustrated embodiment, co-axial with) a central axis 111 of fluid container 100B (e.g. a longitudinal axis of fluid container 100B that intersects a centroid of fluid container 100).

It may be desirable for radiation emitted by UV-LED 105 to irradiate (i.e. provide sufficient fluence to) the entire (or some suitably large threshold percentage of the) volume of cavity 130 to properly disinfect fluid 120 stored in cavity 130. This may be achieved, for example if the beam spread of UV-LED is sufficiently broad so as to irradiate an entire surface 134 of fill plane 132. For the purposes herein, beam spread is defined to be the total angle in which the radiation intensity emitted by a light source is greater than or equal to 50% of the maximal (in the principal radiation direction) intensity. However, the beam spread of typical UV-LEDs 105 used for disinfection is in a range between approximately 100° and 150° (typically, around 120°). Thus, to achieve a beam spread of UV-LED that is sufficiently broad so as to irradiate an entire surface 134 of fill plane 132, distance 142 may have to be relatively large (e.g. in relation to the depth 150 of fluid container 130) which could undesirably result in a cavity 130 having a relatively smaller volume (for a given total height of fluid container system 100).

FIG. 1 schematically illustrates the beam spread of radiation 115 emitted by UV-LED 105 as beam spread 112. It will be appreciated that the intensity of radiation 115 (and thus the radiation fluence delivered to fluid 120 outside of beam spread 112) drops significantly outside of beam spread 112. To irradiate the entire volume of cavity 130 (or some suitably large percentage thereof), it is desirable that radiation 115 within beam spread 112 at least span the surface 134 of fill plane 132 of cavity 130. It will be appreciated that for a given beam spread 112, achieving radiation 115 across the entire surface 134 of fill plane 132 of cavity 130 influences the dimension 142 between UV-LED 105 and fill plane 132 of cavity 130. That is, for a given beam spread, if the surface 134 of the fill plane 132 of cavity 130 is relatively large, the dimension 142 must also be relatively large. However, increasing the dimension 142 is undesirable where the total height of system 100 is limited, because increases in dimension 142 mean that the height 140 of disinfectant head 100A must be similarly increased, in turn decreasing the relative depth of cavity 130 (for a given height constraint) and thereby reducing the storage capacity of system 100.

Another aspect of the invention provides an ultraviolet disinfectant head comprising an ultraviolet light emitting diode (UV-LED) having a principal emission axis and a lens (e.g. a diverging lens) having a primary optical axis. The lens is located and/or oriented to receive radiation from the UV-LED and direct refracted radiation toward the cavity of the fluid container. In some embodiments, the radiation is refracted such that the refracted radiation is diverging when it reaches a fill plane of the fluid container. By providing a diverging lens, the UV-LED may be spaced apart from the fill plane of the fluid container by a relatively smaller distance as compared to the FIG. 1 embodiment.

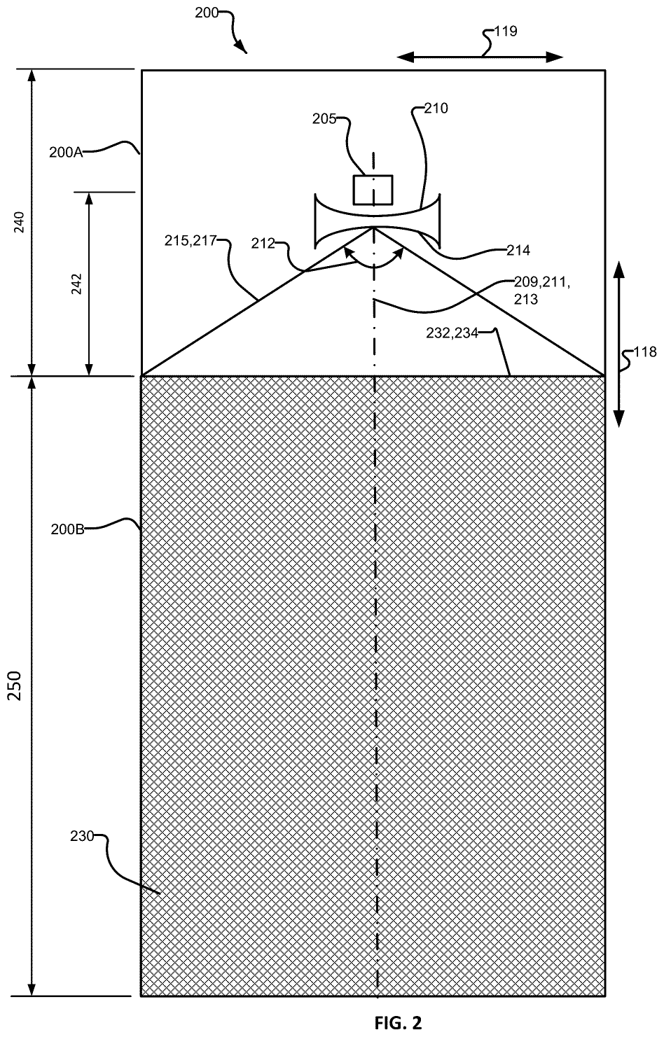

FIG. 2 is a schematic side cross-sectional view of a fluid container system 200 comprising a UV disinfectant head 200A and a fluid container 200B according to an embodiment of the invention. In many respects, fluid container system 200 is substantially similar to fluid container system 100. Accordingly, for convenience, components of fluid container system 200 of the FIG. 2 embodiment that are similar to components of fluid container system 100 of the FIG. 1 embodiment use similar reference numerals (e.g. wherein the digits and trailing letters of the reference numerals of like components are the same except for the first digit which is specific to the embodiment). This practice is continued herein such that components of the various fluid container systems that are similar to one another are described with similar reference numerals (e.g. wherein the digits and trailing letters of the reference numerals of like components are the same except for the first digit which is specific to the embodiment). Unless the context or description dictates otherwise, it should be understood that when referring to features and/or characteristics of components with similar reference numerals, the corresponding description should be understood to apply to any of the particular components with such similar reference numerals.

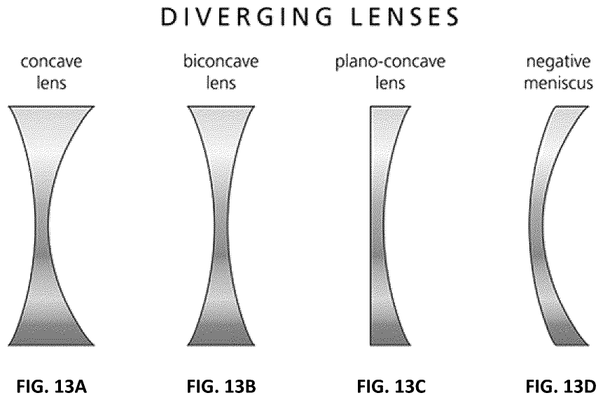

Disinfectant head 200A differs from disinfectant head 100A in that disinfectant head 200A additionally comprises one or more optical lenses 210 which shape the radiation emitted by UV-LED 205 to provide a diverging radiation pattern 217. For simplicity, in the illustrated embodiment, optical lens 210 is shown as a single diverging optical lens. For example, optical lens 210 may comprise a concave lens, a biconcave lens, a plano-concave lens or a negative meniscus lens as depicted in FIGS. 13A-13D (collectively, FIG. 13). However, it should be appreciated that the diverging effect of optical lens 210 may also be achieved by a combination of a plurality of lenses. By way of non-limiting example, such a plurality of lenses could include a combination of a concave lens and a (converging) plano-convex lens. Such a combination of lenses could be arranged in series and/or in parallel.

As with UV-LED 105, UV-LED 205 emits radiation 215 having a principal emission axis 209. UV-LED 205 may be arranged such that principal emission axis 209 of UV-LED 205 may be parallel to primary optical axis 211 of optical lens 210. UV-LED 205 may be arranged such that principal emission axis 209 of UV-LED 205 may be co-axial with primary optical axis 211 of optical lens 210. UV-LED 205 may be arranged such that principal emission axis 209 may be parallel to a central axis 213 of cavity 230. UV-LED 205 may be arranged such that principal emission axis 209 may be co-axial with a central axis 213 of cavity 230. For example, in the illustrated embodiment, UV-LED 205 may be arranged such that principal emission axis 209 of UV-LED 205 is co-axial with primary optical axis 211 of optical lens 210 and central axis 213 of cavity 230.

Due to the presence of optical lens 210, diverging radiation pattern 217 may have a relatively wide beam spread 212 (e.g. relative to beam spread 112 of LED 105 alone). By way of non-limiting example, in some embodiments, lens 205 may be positioned and/or shaped to increase the beam spread of UV-LED 205 by a factor of between approximately 1.2 and 2.0 or between approximately 1.3 and 1.7.

The shape 214 of optical lens 210 and/or location of optical lens relative to UV-LED 205 and/or the index of refraction of optical lens 210 may be changed to account for the dimensions of disinfectant head 200A and/or the dimensions of fluid container 200B to achieve a configuration wherein UV radiation 215 within beam spread 212 is incident on the entire surface 234 of fill plane 232 of cavity 230.

By widening beam spread 212 (e.g. relative to beam spread 112) with lens 210, the distance 242 from which UV-LED 205 is spaced apart from fill plane 232 of cavity 230 can be reduced relative to the distance 142 from which UV-LED 105 is spaced apart from fill plane 132 of cavity 130 of the FIG. 1 container 100 while still providing radiation 215 within beam spread 212 that at least spans the surface 234 of fill plane 232 of cavity 230. Since distance 242 may be reduced relative to distance 142, height 240 of UV disinfectant head 200A may also be reduced relative to height 140 of disinfectant head 100A. In turn, the total height of fluid container system 200 (e.g. the sum of height 240 and depth 250) may be relatively less than the total height of fluid container system 100 for an equal volume of fluid storage capacity or the volume of fluid storage capacity of fluid container system 200 may be relatively greater than the volume of fluid storage capacity of fluid container system 100 for an equal height.

In some embodiments, it may be desirable to provide one or more additional components within a UV disinfectant head. For example, it may be desirable to provide a filter to filter fluids going into and/or out of the fluid container. However, it may be desirable that such components are located in a location which conflicts with the previously discussed locations of UV-LEDs and/or optical lenses. Further or alternatively, such components may interfere with radiation outputted by the UV-LED thereby reducing the efficiency of the disinfectant head and/or causing at least some portion of fluid not to be disinfected.

Another aspect of the invention provides a UV disinfectant head wherein the UV-LED and the diverging lens are arranged to accommodate the presence of a component such as a filter by arranging the UV-LED and/or the diverging lens to achieve one or more of the following configurations:
the principal emission axis of the UV-LED is parallel to and spaced apart from the central axis of the fluid container;
the principal emission axis of the UV-LED is non-parallel to and spaced apart from the central axis of the fluid container;
the principal emission axis of the UV-LED is spaced apart from and oriented at an acute angle relative to the central axis of the fluid container;
the primary optical axis of the diverging lens is parallel to and spaced apart from the central axis of the fluid container;
the primary optical axis of the diverging lens is non-parallel to and spaced apart from the central axis of the fluid container;
the primary optical axis of the diverging lens is spaced apart from and oriented at an acute angle relative to the central axis of the fluid container;
the primary optical axis of the diverging lens is parallel to and spaced apart from the principal emission axis of the UV-LED;
the primary optical axis of the diverging lens is non-parallel to and spaced apart from the principal emission axis of the UV-LED;
the primary optical axis of the diverging lens is spaced apart from and oriented at an acute angle relative to the principal emission axis of the UV-LED; and/or
the diverging lens is asymmetrical.

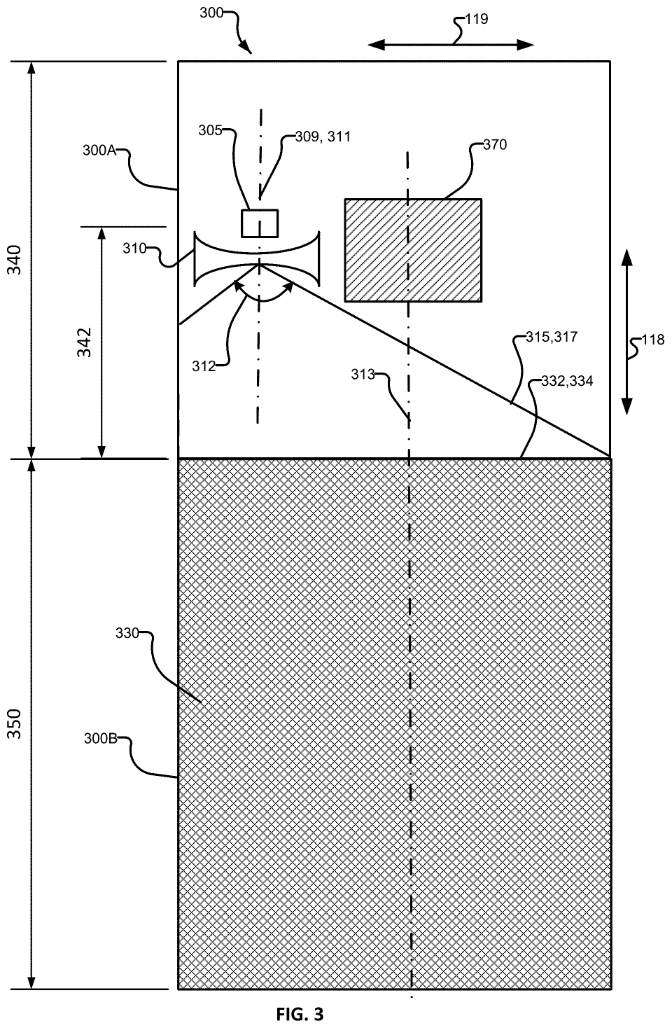

FIGS. 3 to 9 illustrate exemplary configurations of UV-LEDs and diverging lenses arranged to accommodate the presence of a component such as a filter.

FIG. 3 is a schematic side cross-sectional view of a fluid container system 300 comprising a UV disinfectant head 300A and a fluid container 300B according to an embodiment of the invention. Fluid container system 300 is substantially similar to fluid container system 200. For example, disinfectant head 300A comprises a filter 370 and a UV-LED 305 having a principal emission axis 309. UV-LED emits radiation 315 having a beam spread 312. An optical lens 305 (e.g. a diverging lens) having a primary optical axis 311 receives radiation 315 emitted from UV-LED 305 and directs refracted radiation 315 in diverging radiation pattern 317 toward the cavity 330 of fluid container 300B (which has a central axis 313). Radiation 315 is diverging when it reaches a surface 334 of a fill plane 332 of fluid container 300B. Disinfectant head 300A has a height 340 while fluid container 300B has a depth 350. UV-LED may be spaced apart from fill plane 332 in longitudinal direction 118 by a distance 342. However, fluid container system 300 differs from fluid container system 200 as follows.

Fluid container system 300 differs from the previously described embodiments in that UV disinfectant head 300A comprises a physical filter 370. Filter 370 may comprise a water filter. Filter 370 may comprise any suitable water filter such as, for example, a membrane filter, a charcoal-based filter and/or the like. Filter 370 may physically filter fluid as it is added to cavity 330 and/or removed from cavity 330. In the illustrated embodiment, filter 370 is located in disinfectant head 300A. This is not necessary and filter 370 may be located in cavity 330 (e.g. filter may extend from disinfectant head 300A into cavity 330). In the illustrated embodiment, filter 370 is generally aligned with (e.g. is intersected by) central axis 313 of fluid container 300B, although this is not necessary. It will be appreciated that filter 370 could block, attenuate and/or occlude UV radiation 315 from reaching fluid housed in cavity 330 due to its location relative to UV-LED 305 (e.g. if UV-LED was located similarly to UV-LED 105 or UV-LED 205).

Like UV-LED 205, UV-LED 305 is arranged to emit radiation 315 having a principal emission axis 309 which may be parallel with and even co-axial with primary optical axis 311 of optical lens 310. However, fluid container system 300 differs from fluid container system 200 in that UV-LED 305 and lens 310 may be arranged such that principal emission axis 309 of UV-LED 305 and primary optical axis 311 of lens 310 are parallel to, but spaced apart from central axis 313 of fluid container 300B in a transverse direction 119. Transverse direction 119 may be orthogonal to central axis 313 of cavity 330. The amount by which UV-LED 305 and lens 310 (and in turn principal emission axis 309 and primary optical axis 311) are spaced apart from central axis 313 may depend at least in part on the shape and location of filter 370. For example, the amount by which UV-LED 305 and lens 310 are spaced apart from central axis 313 may be chosen such that radiation 315 is not incident with filter 370 or such that an amount of radiation 315 that is incident with filter 370 is minimized.

This transverse direction 119 spacing apart of UV-LED 305 and lens 310 (and principal emission axis 309 and primary optical axis 311) from central axis 313, may avoid having radiation from UV-LED occluded by filter 370 (e.g. where filter 370 is intersected by central axis 313 as in the illustrated embodiment).

Despite the spacing apart of UV-LED 305 and lens 310 from central axis 313, fluid container system 300 shares at least some of the previously discussed advantages of fluid container system 200 over fluid container system 100 due to the wide beam spread 312 provided by lens 310. Moreover, fluid container system 300 has the additional advantage of having UV-LED 305 and lens 310 spaced apart in transverse direction 119 central axis 313, which may avoid having radiation 315 from UV-LED 305 occluded by filter 370.

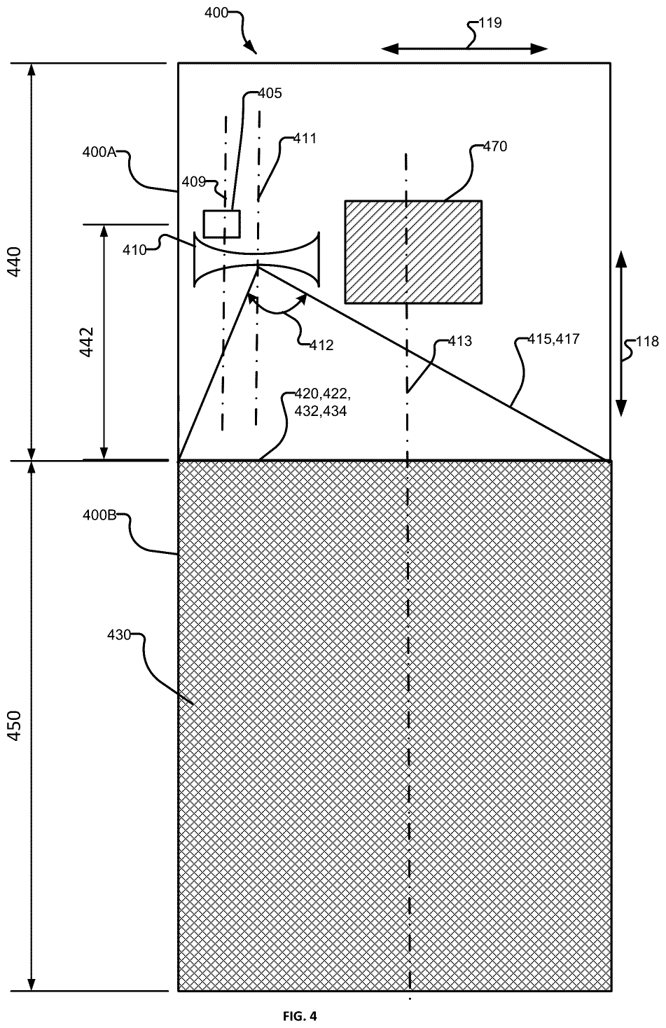

FIG. 4 is a schematic side cross-sectional view of a fluid container system 400 comprising a UV disinfectant head 400A and a fluid container 400B according to an embodiment of the invention. Fluid container system 400 is substantially similar to fluid container system 300. For example, disinfectant head 400A comprises a filter 470 and a UV-LED 405 having a principal emission axis 409. UV-LED emits radiation 415 having a beam spread 412. An optical lens 405 (e.g. a diverging lens) having a primary optical axis 411 receives radiation 415 emitted from UV-LED 405 and directs refracted radiation 415 in diverging radiation pattern 417 toward the cavity 430 of fluid container 400B (which has a central axis 413). Radiation 415 is diverging when it reaches a surface 434 of a fill plane 432 of fluid container 400B. Disinfectant head 400A has a height 440 while fluid container 400B has a depth 450. UV-LED may be spaced apart from fill plane 432 in longitudinal direction 118 by a distance 442. However, fluid container system 400 differs from fluid container system 300 as follows.

While UV-LED 305 of fluid container system 300 is arranged such that principal emission axis 309 is co-axial to primary optical axis 311, UV-LED 405 is arranged such that principal emission axis 409 of UV-LED 405 is parallel to, but spaced apart in transverse direction 119 from primary optical axis 411 of lens 410. By spacing apart principal emission axis 409 and primary optical axis 411 in transverse direction 119, the combination of UV-LED 405 and lens 410 generate an asymmetrical diverging radiation pattern 417 (as compared to symmetric diverging radiation pattern 317 of UV-LED 305 and optical lens 310). Asymmetrical diverging radiation pattern 417 may be directed (e.g. by increasing or reducing the amount by which principal emission axis 409 and primary optical axis 411 are spaced apart in transverse direction 119) to reduce the amount of radiation 415 impinging on the inner walls of UV disinfectant head 400A and/or cavity 430 (relative to the amount of radiation 315 impinging on the inner walls of UV disinfectant head 300A and/or cavity 330). This effect can be seen by comparing the shape of radiation 315 depicted in FIG. 3 to the shape of radiation 415 depicted in FIG. 4.

By reducing the amount of radiation 415 impinging on the inner walls of UV disinfectant head 400A and/or cavity 430 (relative to the amount of radiation 315 impinging on the inner walls of UV disinfectant head 300A and/or cavity 330), the efficiency of fluid container system 400 may be increased relative to, for example, fluid container system 300 since radiation 415 impinging on the inner walls of UV disinfectant head 400A and/or cavity 430 may result in a loss of radiation 415 as radiation 415 scattered, absorbed or reduced in energy levels by the inner walls of UV disinfectant head 400A and/or cavity 430. In other words, fluid container system 400 may therefore be more energy efficient than fluid container system 300 because a larger fraction of the energy used to generate radiation 415 (and a larger fraction of the generated radiation 415) is used to disinfect fluid contained in cavity 430.

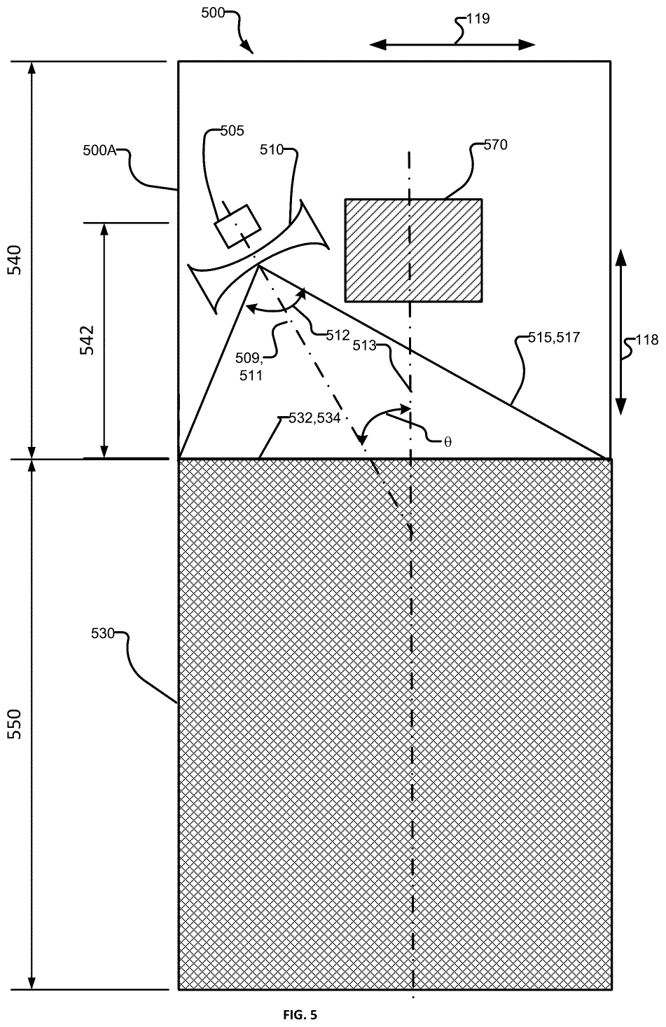

FIG. 5 is a schematic side cross-sectional view of a fluid container system 500 comprising a UV disinfectant head 500A and a fluid container 500B according to an embodiment of the invention. Fluid container system 500 is substantially similar to fluid container system 300. For example, disinfectant head 500A comprises a filter 570 and a UV-LED 505 having a principal emission axis 509. UV-LED emits radiation 515 having a beam spread 512. An optical lens 505 (e.g. a diverging lens) having a primary optical axis 511 receives radiation 515 emitted from UV-LED 505 and directs refracted radiation 515 in diverging radiation pattern 517 toward the cavity 530 of fluid container 500B (which has a central axis 513). Radiation 515 is diverging when it reaches a surface 534 of a fill plane 532 of fluid container 500B. Disinfectant head 500A has a height 540 while fluid container 500B has a depth 550. UV-LED may be spaced apart from fill plane 532 in longitudinal direction 118 by a distance 542. However, fluid container system 500 differs from fluid container system 300 as follows.

While UV-LED 305 and lens 310 of fluid container system 300 are arranged such that principal emission axis 309 and primary optical axis 311 are co-axial with each other and parallel to central axis 313 of fluid container 300B, UV-LED 505 and lens 510 of fluid container system 500 are arranged such that principal emission axis 509 and primary optical axis 511 are oriented at an angle Θ relative to central axis 513 of fluid container 500B. By orienting UV-LED 505 and lens 510 in such a way, lens 510 transmits an asymmetrical diverging radiation pattern 517 (as compared to symmetric diverging radiation pattern 317 of UV-LED 305 and optical lens 310). Asymmetrical diverging radiation pattern 517 may be directed (e.g. by increasing or decreasing angle Θ relative to central axis 513) to reduce the amount of radiation 515 impinging on the inner walls of UV disinfectant head 500A and/or cavity 530 (relative to the amount of radiation 315 impinging on the inner walls of UV disinfectant head 300A and/or cavity 330). This effect can be seen by comparing the shape of radiation 315 depicted in FIG. 3 to the shape of radiation 515 depicted in FIG. 5. As such, fluid container system 500 may benefit from the same or similar gains in efficiency as discussed herein in relation to fluid container system 400.

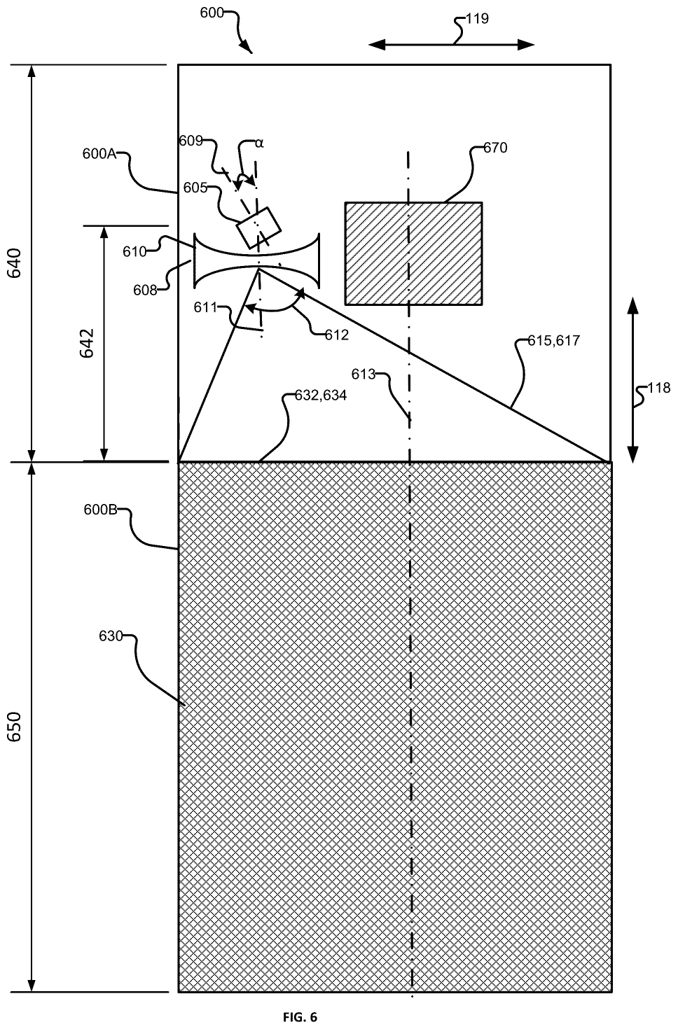

FIG. 6 is a schematic side cross-sectional view of a fluid container system 600 comprising a UV disinfectant head 600A and a fluid container 600B according to an embodiment of the invention. Fluid container system 600 is substantially similar to fluid container system 300. For example, disinfectant head 600A comprises a filter 670 and a UV-LED 605 having a principal emission axis 609. UV-LED emits radiation 615 having a beam spread 612. An optical lens 605 (e.g. a diverging lens) having a primary optical axis 611 receives radiation 615 emitted from UV-LED 605 and directs refracted radiation 615 in diverging radiation pattern 617 toward the cavity 630 of fluid container 600B (which has a central axis 613). Radiation 615 is diverging when it reaches a surface 634 of a fill plane 632 of fluid container 600B. Disinfectant head 600A has a height 640 while fluid container 600B has a depth 650. UV-LED may be spaced apart from fill plane 632 in longitudinal direction 118 by a distance 642. However, fluid container system 600 differs from fluid container system 300 as follows.

While UV-LED 305 and lens 310 of fluid container system 300 are arranged such that principal emission axis 309 and primary optical axis 311 are co-axial with each other and parallel to central axis 313 of fluid container 300B, UV-LED 605 of fluid container system 600 is arranged such that principal emission axis 609 is oriented at an angle α relative to central axis 613 of fluid container 500B and lens 610 is arranged such that primary optical axis 611 is parallel to (and spaced apart from) central axis 613. In this way, principal emission axis 609 is oriented at angle α relative to primary optical axis 611. By orienting UV-LED 605 and lens 610 such that principal emission axis 609 is oriented at angle α relative to primary optical axis 611, lens 610 transmits an asymmetrical diverging radiation pattern 617 (as compared to symmetric diverging radiation pattern 317 of UV-LED 305 and optical lens 310). Asymmetrical diverging radiation pattern 617 may be directed (e.g. by increasing or decreasing angle α relative to primary optical axis 611) to reduce the amount of radiation 615 impinging on the inner walls of UV disinfectant head 600A and/or cavity 630 (relative to the amount of radiation 315 impinging on the inner walls of UV disinfectant head 300A and/or cavity 330). This effect can be seen by comparing the shape of radiation 315 depicted in FIG. 3 to the shape of radiation 615 depicted in FIG. 6. As such, fluid container system 600 may benefit from the same or similar gains in efficiency as discussed herein in relation to fluid container system 400.

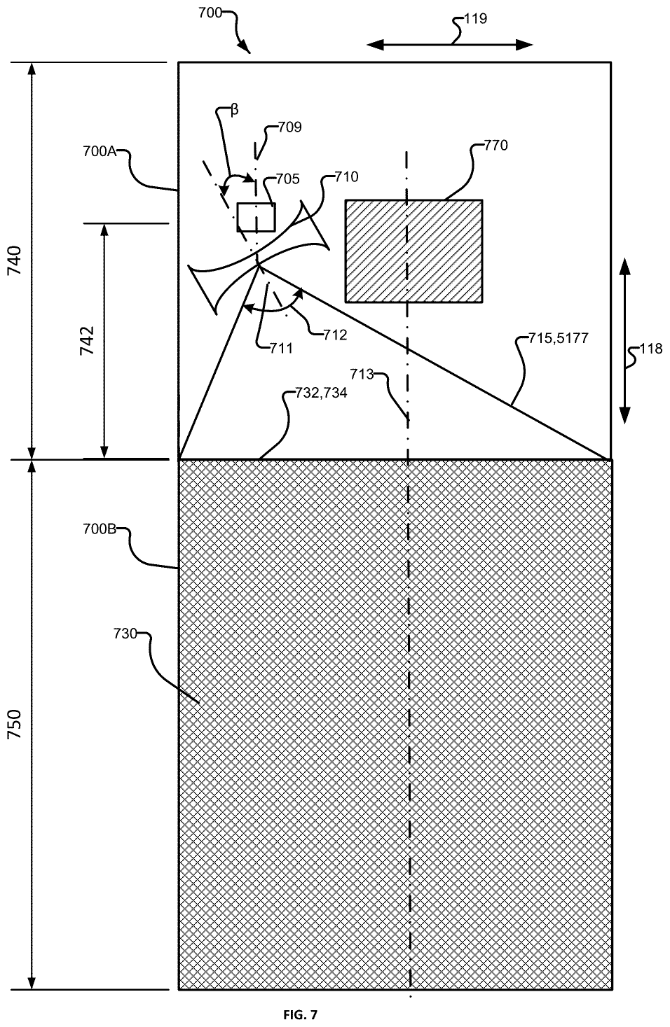

FIG. 7 is a schematic side cross-sectional view of a fluid container system 700 comprising a UV disinfectant head 700A and a fluid container 700B according to an embodiment of the invention. Fluid container system 700 is substantially similar to fluid container system 300. For example, disinfectant head 700A comprises a filter 770 and a UV-LED 705 having a principal emission axis 709. UV-LED emits radiation 715 having a beam spread 712. An optical lens 705 (e.g. a diverging lens) having a primary optical axis 711 receives radiation 715 emitted from UV-LED 705 and directs refracted radiation 715 in diverging radiation pattern 717 toward the cavity 730 of fluid container 700B (which has a central axis 713). Radiation 715 is diverging when it reaches a surface 734 of a fill plane 732 of fluid container 700B. Disinfectant head 700A has a height 740 while fluid container 700B has a depth 750. UV-LED may be spaced apart from fill plane 732 in longitudinal direction 118 by a distance 742. However, fluid container system 700 differs from fluid container system 300 as follows.

While UV-LED 305 and lens 310 of fluid container system 300 are arranged such that principal emission axis 309 and primary optical axis 311 are co-axial with each other and parallel to central axis 313 of fluid container 300B, UV-LED 705 of fluid container system 700 is arranged such that principal emission axis 709 is parallel to central axis 713 of fluid container 500B and lens 710 is arranged such that primary optical axis 711 is spaced apart from and oriented at an angle β relative to central axis 713. In this way, primary optical axis 711 is oriented at angle β relative to principal emission axis 709. By orienting UV-LED 705 and lens 710 such that is oriented at angle β relative to principal emission axis 709, lens 710 transmits an asymmetrical diverging radiation pattern 717 (as compared to symmetric diverging radiation pattern 317 of UV-LED 305 and optical lens 310). Asymmetrical diverging radiation pattern 717 may be directed (e.g. by increasing or decreasing angle β relative to principal emission axis 709) to reduce the amount of radiation 715 impinging on the inner walls of UV disinfectant head 700A and/or cavity 730 (relative to the amount of radiation 315 impinging on the inner walls of UV disinfectant head 300A and/or cavity 330). This effect can be seen by comparing the shape of radiation 315 depicted in FIG. 3 to the shape of radiation 715 depicted in FIG. 7. As such, fluid container system 700 may benefit from the same or similar gains in efficiency as discussed herein in relation to fluid container system 400.

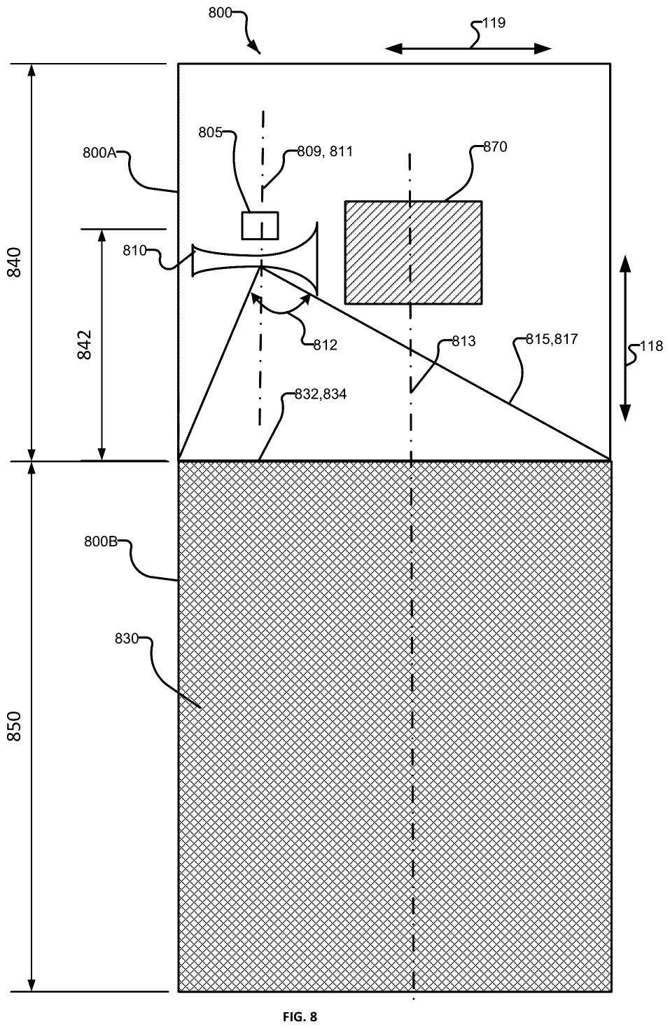

FIG. 8 is a schematic side cross-sectional view of a fluid container system 800 comprising a UV disinfectant head 800A and a fluid container 800B according to an embodiment of the invention. Fluid container system 800 is substantially similar to fluid container system 300. For example, disinfectant head 800A comprises a filter 870 and a UV-LED 805 having a principal emission axis 809. UV-LED emits radiation 815 having a beam spread 812. An optical lens 805 (e.g. a diverging lens) having a primary optical axis 811 receives radiation 815 emitted from UV-LED 805 and directs refracted radiation 815 in diverging radiation pattern 817 toward the cavity 830 of fluid container 800B (which has a central axis 813). Radiation 815 is diverging when it reaches a surface 834 of a fill plane 832 of fluid container 800B. Disinfectant head 800A has a height 840 while fluid container 800B has a depth 850. UV-LED may be spaced apart from fill plane 832 in longitudinal direction 118 by a distance 842. However, fluid container system 800 differs from fluid container system 300 as follows.

While lens 310 of fluid container system 300 is depicted as being symmetrical about its primary optical axis 311, lens 810 is asymmetrical relative to primary optical axis 811 (and relative to the principal emission axis 809 of UV-LED 805). Due to the asymmetry of lens 810 relative to primary optical axis 811, lens 810 transmits an asymmetrical diverging radiation pattern 817 (as compared to symmetric diverging radiation pattern 317 of UV-LED 305 and optical lens 310). Asymmetrical diverging radiation pattern 817 may be directed (e.g. by altering the amount and shape of the asymmetry of lens 810) to reduce the amount of radiation 815 impinging on the inner walls of UV disinfectant head 800A and/or cavity 830 (relative to the amount of radiation 315 impinging on the inner walls of UV disinfectant head 300A and/or cavity 330). This effect can be seen by comparing the shape of radiation 315 depicted in FIG. 3 to the shape of radiation 815 depicted in FIG. 8. As such, fluid container system 800 may benefit from the same or similar gains in efficiency as discussed herein in relation to fluid container system 400.

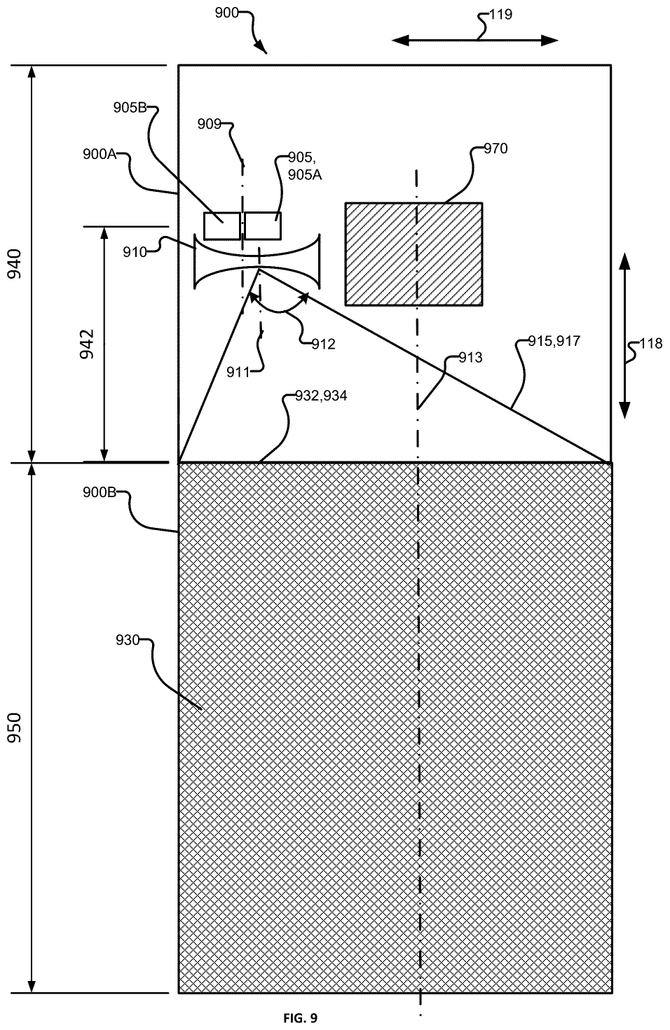

While the UV-LEDs of the various fluid container systems described herein (e.g. fluid container systems 100, 200, 300, 400, 500, 600, 700 and 800) are shown in the illustrated drawings as being single UV-LEDs, this is not mandatory. Instead, each UV-LED discussed and/or depicted herein could comprise a plurality of UV-LEDs, as shown, for example, in FIG. 9.

FIG. 9 is a schematic side cross-sectional view of a fluid container system 900 comprising a UV disinfectant head 900A and a fluid container 900B according to an embodiment of the invention. Fluid container system 900 is substantially similar to fluid container system 400 except as follows. Disinfectant head 900A comprises a filter 970 and a pair UV-LED 905 having a combined principal emission axis 909 (e.g. an axis 909 on which the intensity of emitted radiation from the plurality of LEDs 905 is maximal) rather than a single UV-LED 405 having a principal emission axis 409. UV-LEDs together emit radiation 915 having a beam spread 912. An optical lens 905 (e.g. a diverging lens) having a primary optical axis 911 receives radiation 915 emitted from UV-LEDs 905 and directs refracted radiation 915 in diverging radiation pattern 917 toward the cavity 930 of fluid container 900B (which has a central axis 913). Radiation 915 is diverging when it reaches a surface 934 of a fill plane 932 of fluid container 900B. Disinfectant head 900A has a height 940 while fluid container 900B has a depth 950. UV-LED may be spaced apart from fill plane 932 in longitudinal direction 118 by a distance 942.

The embodiments of FIGS. 3 to 9 described herein provide a number of techniques for generating radiation distributions which effectively mitigate the impingement or blocking of radiation by physical filters while creating a radiation distribution that can be configured to provide sufficient fluence (radiation or doses) to the volume of fluid housed in the cavities of the fluid containers. Such techniques include, for example, transversely offsetting the UV-LED and lens relative to the physical filter, transversely offsetting the UV-LED and lens relative to one another, orienting the UV-LED and lens at different orientations (relative to a central axis of the fluid-housing mechanism and/or relative to one another), and/or providing an asymmetrical lens. It will be appreciated that any such techniques could be suitably combined to achieve desired radiation distributions. By way of non-limiting example, FIG. shows a fluid container system 500 where principal emission axis 509 and primary optical axis 511 are angularly offset from the vertical and/or from central axis 513 of fluid container 100B but this embodiment could be modified to spatially offset principal emission axis 509 and primary optical axis 511 from one another (in a manner similar to fluid container system 400) and/or to provide lens 510 with an asymmetrical profile (in a manner similar to fluid container system 800).

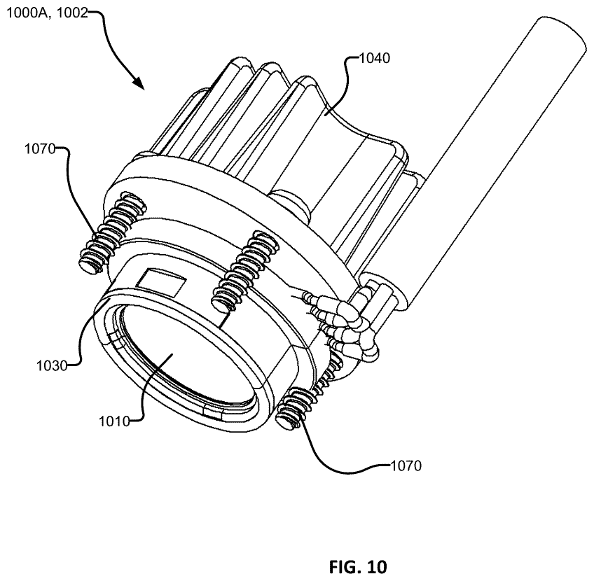

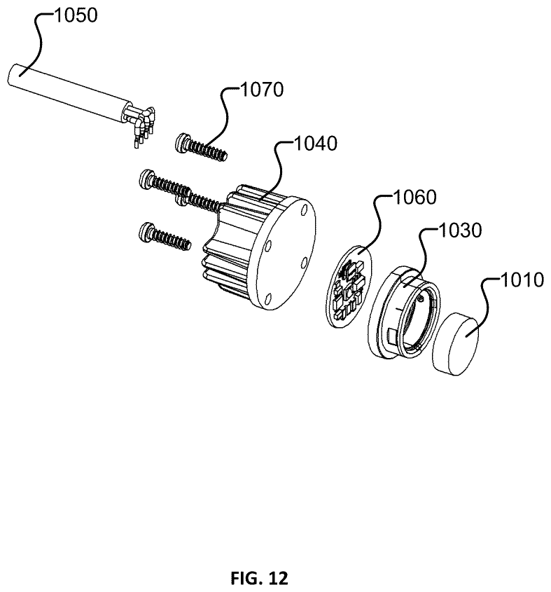

FIGS. 10 to 12 depict a portion 1002 of a UV disinfectant head 1000A according to an embodiment of the invention. For simplicity, the remaining portion of UV disinfectant head 1000A (including the physical filter) is not shown in FIGS. 10 to 12. Portion 1002 shown in FIGS. 10 to 12 supports lens 1010 and UV-LED 1005. In the particular case of the illustrated embodiment, portion 1002 may be removably attached to a remainder of UV disinfectant head 1000A using, by way of non-limiting example, fasteners 1070, although other types of connections (e.g. snap-together fittings, a screw-together fitting, an adhesive fitting, and/or the like) could be provided.

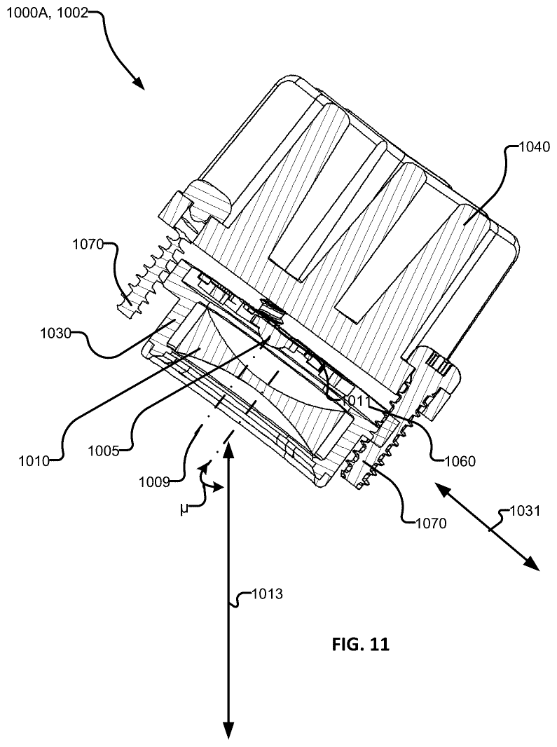

As shown best by FIG. 11, UV-LED 1005 may be provided on a PCBA board 1060, which may house associated electronics and/or a battery for driving LED 1005. UV-LED 1005 may be located and/or oriented to have a principal emission axis 1009 which may be parallel to, but offset in a transverse direction (shown by double-headed arrow 1031) from, primary optical axis 1011 of lens 1010. Further, both principal emission axis 1009 and primary optical axis 1011 may be oriented at an angle μ relative to a central axis 1013 of a fluid container (not shown). In this regard, portion 1002 of disinfectant head 1000B may provide functionality similar to that of a combination of disinfectant head 400A and disinfectant head 500A. In the illustrated embodiment, lens 1010 forms part of a housing 1030 which houses PCBA 1060 and LED 1005. The backing of housing 1030 may be provided by a heat sink 1040 which may be in thermal contact with the PCBA for conducting heat away from LED 1005 and PCBA 1060. Power may be provided to PCBA 1060 and UV-LED 1005 via a suitably wire housing 1060 or battery housing.

The above mentioned embodiments may be combined into any suitable combination to achieve a desired radiation profile. Potential combinations which have not been depicted in the Figures may include a disinfectant head where: a UV-LED is offset from the central axis of an optical lens which has a curvature which is greater on one side of the central axis than on the other; multiple UV-LEDs are offset from the central axis of an optical lens which has a curvature which is greater on one side of the central axis than on the other; a UV-LED is oriented at an (acute) angle relative to an optical lens which has a curvature which is greater on one side of the central axis than on the other; an optical lens which has a curvature which is greater on one side of the central axis than on the other which is oriented at an (acute) angle relative to a UV-LED; both a UV-LED and an optical lens which has a curvature which is greater on one side of the central axis than on the other are oriented at an (acute) angle relative to the surface of a fluid which is intended to be disinfected; both a UV-LED and an optical lens which has a curvature which is greater on one side of the central axis than on the other are oriented at an (acute) angle relative to the surface of a fluid which is intended to be disinfected and the UV-LED is positioned near the edge of the optical lens; both an array of UV-LEDs and an optical lens which has a curvature which is greater on one side of the central axis than on the other are oriented at an (acute) angle relative to the surface of a fluid which is intended to be disinfected and the UV-LED is positioned near the edge of the optical lens; an array of UV-LEDs are oriented at an (acute) angle relative to an optical lens which has a curvature which is greater on one side of the central axis than on the other and the UV-LEDs are positioned near the edge of the optical lens; a UV-LED is oriented at an (acute) angle relative to, and positioned near the edge of an optical lens which has a curvature which is greater on one side of the central axis than on the other; a UV-LED positioned near the edge of an optical lens which has a curvature which is greater on one side of the central axis than on the other and the optical lens which is oriented at an (acute) angle relative to the UV-LED; an array of UV-LEDs positioned near the edge of an optical lens which has a curvature which is greater on one side of the central axis than on the other and the optical lens which is oriented at an (acute) angle relative to the UV-LEDs.

Another aspect of the invention provides methods and systems for controlling disinfectant heads (e.g. the disinfectant heads described herein such as disinfectant head 100A, 200A, 300A, 400A, etc.). The control methods may be implemented by one or more suitable controllers integrated with or connected to the disinfectant head (e.g. any of the disinfectant heads described herein such as disinfectant head 100A, 200A, 300A, 400A, etc.). For example, disinfectant head 100A may comprise a controller 160. For convenience, the following control methods and systems are described in relation to disinfectant head 100A but it should be understood that such control methods and systems may be employed for any disinfectant heads described herein or elsewhere.

In some embodiments, drive current provided to illuminate UV-LED 105 may be controlled by controller 160 based on a temperature of UV-LED 105. The temperature of UV-LED 105 may be provided by a temperature sensor 162 configured to measure a temperature of UV-LED 105 such as, for example, a thermocouple. In some embodiments, the temperature of UV-LED 105 may not be directly measured but may instead be estimated based at least in part on, for example, a cumulative amount of current provided to UV-LED 105 during a period of time or a run time of UV-LED 105. When a temperature (measured or estimated) of UV-LED 105 reaches a threshold, the drive current provided to UV-LED 105 may be reduced to allow UV-LED 105 to reduce a risk of overheating of UV-LED 105. In some embodiments, When a temperature (measured or estimated) of UV-LED 105 reaches a threshold, the drive current provided to UV-LED 105 may be reduced to at or near zero.

In some embodiments, drive current provided to illuminate UV-LED 105 may be controlled by controller 160 based at least in part on a period of time during which UV-LED 105 is off (e.g. no drive current or substantially no drive current is provided to UV-LED 105). For example, if after a threshold period, UV-LED 105 has not turned on, drive current may be provided to UV-LED 105 to ensure that any fluid 120 in cavity 130 is disinfected. This may be beneficial as previously disinfected fluid 120 stored within cavity 130 may need further disinfecting after the threshold period of time due to growth of bacteria and/or the like.

In some embodiments, drive current provided to illuminate UV-LED 105 may be controlled by controller 160 based at least in part on a flow of fluid 120 into cavity 130 of fluid container 100B. The flow of fluid 120 into cavity 130 may be measured, for example, by a flow sensor 164 (e.g. a flow meter such as a gravimetric flow meter) provided to measure a rate of flow of fluid 120 into cavity 130. In some embodiments, the flow of fluid 120 into cavity 130 may be measured indirectly by measuring a volume, depth or level of fluid 120 within cavity 130 (e.g. with a fluid level sensor) and comparing such measurements across a period of time. When more fluid 120 flows into cavity 130, the drive current provided to UV-LED 105 may be increased (e.g. UV-LED 105 may be turned on). The period of time during which UV-LED 105 is turned on and/or the magnitude of the drive current provided to UV-LED 105 may be dependent on the amount of fluid 120 that is entering or has entered cavity 130 and/or the rate at which fluid 120 is entering cavity 130. For example, the period of time during which UV-LED 105 is turned on and/or the magnitude of the drive current provided to UV-LED 105 may be increased for to an increased amount of fluid 120 that is entering or has entered cavity 130 and/or an increased rate at which fluid 120 is entering cavity 130.

In some embodiments, the drive current provided to illuminate UV-Led 105 may be controlled by controller 160 based at least in part on a UV transmissivity of fluid 120. For example, the period of time during which UV-LED 105 is turned on and/or the magnitude of the drive current provided to UV-LED 105 may be dependent on a UV transmissivity of fluid 120. In some embodiments, the period of time during which UV-LED 105 is turned on and/or the magnitude of the drive current provided to UV-LED 105 may be increased for relatively lower UV transmissivities of fluid 120. The UV transmissivity of fluid 120 may be measured by one or more transmittance sensors 166 located in disinfectant head 100A or otherwise.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### INTERPRETATION OF TERMS

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Where a record, field, entry, and/or other element of a database is referred to above, unless otherwise indicated, such reference should be interpreted as including a plurality of records, fields, entries, and/or other elements, as appropriate. Such reference should also be interpreted as including a portion of one or more records, fields, entries, and/or other elements, as appropriate. For example, a plurality of “physical” records in a database (i.e. records encoded in the database's structure) may be regarded as one “logical” record for the purpose of the description above and the claims below, even if the plurality of physical records includes information which is excluded from the logical record.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention includes a number of non-limiting aspects. Non-limiting aspects of the invention include:
1. An ultraviolet disinfectant head for disinfecting a fluid housed in a cavity of a fluid container having a central axis, the ultraviolet disinfectant head comprising:
   an ultraviolet light emitting diode (UV-LED) having a principal emission axis; and
   a lens having a primary optical axis, the lens oriented and/or located to receive radiation from the UV-LED and direct refracted radiation toward a fill plane of the cavity of the fluid container.
2. An ultraviolet disinfectant head according to aspect 1 wherein the lens is a diverging lens.
3. An ultraviolet disinfectant head according to aspect 1 wherein that the refracted radiation is diverging when it reaches the fill plane of the fluid container.
4. An ultraviolet disinfectant head according to aspect 1 wherein when the ultraviolet disinfectant head is attached to the fluid container:
   the principal emission axis of the UV-LED is co-axial with the central axis of the fluid container; and
   the principal emission axis of the UV-LED is co-axial with the primary optical axis of the lens.
5. An ultraviolet disinfectant head according to aspect 1 wherein the principal emission axis of the UV-LED is spaced apart from and parallel to the central axis of the fluid container when the ultraviolet disinfectant head is attached to the fluid container.
6. An ultraviolet disinfectant head according to aspect 5 wherein the principal emission axis of the UV-LED is co-axial to the primary optical axis of the lens.
7. An ultraviolet disinfectant head according to aspect 5 wherein the principal emission axis of the UV-LED is spaced apart from and parallel to the primary optical axis of the lens.
8. An ultraviolet disinfectant head according to any one of aspect 5 wherein the principal emission axis of the UV-LED is oriented at a first angle relative to the primary optical axis of the lens and the first angle is an acute angle.
9. An ultraviolet disinfectant head according to aspect 1 wherein the UV-LED is spaced apart from the central axis of the fluid container and the principal emission axis of the UV-LED is non-parallel to the central axis of the fluid container when the ultraviolet disinfectant head is attached to the fluid container.
10. An ultraviolet disinfectant head according to aspect 9 wherein the principal emission axis of the UV-LED is co-axial to the primary optical axis of the lens.
11. An ultraviolet disinfectant head according to aspect 9 wherein the principal emission axis of the UV-LED is spaced apart from and parallel to the primary optical axis of the lens.
12. An ultraviolet disinfectant head according to aspect 9 wherein the primary optical axis of the lens is spaced apart from and parallel to the central axis of the fluid container.
13. An ultraviolet disinfectant head according to aspect 9 wherein the principal emission axis of the UV-LED is oriented at a second angle relative to the primary optical axis of the lens and the second angle is an acute angle.
14. An ultraviolet disinfectant head according to aspect 1 wherein the UV-LED is spaced apart from the central axis of the fluid container and the principal emission axis of the UV-LED is oriented at a third angle relative to the central axis of the fluid container when the ultraviolet disinfectant head is attached to the fluid container and the third angle is an acute angle.
15. An ultraviolet disinfectant head according to aspect 14 wherein the principal emission axis of the UV-LED is co-axial to the primary optical axis of the lens.
16. An ultraviolet disinfectant head according to aspect 14 wherein the principal emission axis of the UV-LED is spaced apart from and parallel to the primary optical axis of the lens.
17. An ultraviolet disinfectant head according to aspect 14 wherein the primary optical axis of the lens is spaced apart from and parallel to the central axis of the fluid container.
18. An ultraviolet disinfectant head according to aspect 14 wherein the principal emission axis of the UV-LED is oriented at a fourth angle relative to the primary optical axis of the lens and the fourth angle is an acute angle.
19. An ultraviolet disinfectant head according to aspect 1 comprising a filter for filtering fluid that passes through the ultraviolet disinfectant head into or out of the fluid container.
20. An ultraviolet disinfectant head according to aspect 19 wherein the central axis of the fluid container intersects the filter when the ultraviolet disinfectant head is attached to the fluid container.
21. An ultraviolet disinfectant head according to aspect 1 wherein the ultraviolet disinfectant head is part of a lid of the fluid container.
22. An ultraviolet disinfectant head according to aspect 1 wherein the ultraviolet disinfectant head is attachable to a mouth of the fluid container.
23. An ultraviolet disinfectant head according to aspect 1 wherein the ultraviolet disinfectant head is attachable to the fluid container between a mouth of the fluid container and a lid of the fluid container.
24. An ultraviolet disinfectant head according to aspect 1 wherein the lens is an asymmetric diverging lens.
25. An ultraviolet disinfectant head according to aspect 1 wherein the lens is an asymmetric diverging lens wherein the asymmetric diverging lens is asymmetric about a central axis of the asymmetric diverging lens.
26. An ultraviolet disinfectant head according to aspect 1 wherein the lens is a concave lens.
27. An ultraviolet disinfectant head according to aspect 1 wherein the lens is a biconcave lens.
28. An ultraviolet disinfectant head according to aspect 1 wherein the lens is a plano-concave lens.
29. An ultraviolet disinfectant head according to aspect 1 wherein the lens is a negative meniscus lens.
30. An ultraviolet disinfectant head according to aspect 1 wherein the ultraviolet disinfectant head comprises a second UV-LED and the lens is oriented and/or located to receive second radiation from the second UV-LED and direct second refracted radiation toward the cavity of the fluid container.
31. An ultraviolet disinfectant head according to aspect 1 wherein the ultraviolet disinfectant head comprises a second lens and the lens and the second lens are together oriented and/or located to receive the radiation from the UV-LED and direct the refracted radiation toward the cavity of the fluid container.
32. An ultraviolet disinfectant head according to aspect 1 comprising a battery to power the UV-LED.
33. An ultraviolet disinfectant head according to aspect 1 comprising a controller configured to control drive current provided to the UV-LED.
34. An ultraviolet disinfectant head according to aspect 33 comprising a temperature sensor for measuring the temperature of the UV-LED and wherein the controller is configured to control the drive current provided to the UV-LED based at least in part on the temperature of the UV-LED.
35. An ultraviolet disinfectant head according to aspect 33 wherein the controller is configured to control the drive current provided to the UV-LED based at least in part on a period of time since the drive current was provided to the UV-LED.
36. An ultraviolet disinfectant head according to aspect 33 comprising a fluid level sensor for determining a level of fluid in the cavity of the fluid container and wherein the controller is configured to control the drive current provided to the UV-LED based at least in part on the level of fluid within the cavity of the fluid container.
37. An ultraviolet disinfectant head according to aspect 33 comprising a flow sensor for determining a rate at which fluid is entering the cavity of the fluid container and wherein the controller is configured to control the drive current provided to the UV-LED based at least in part on the rate at which fluid is entering the cavity of the fluid container.
38. An ultraviolet disinfectant head according to aspect 33 comprising a UV transmittance sensor for determining a UV transmittance of the fluid in the cavity of the fluid container and wherein the controller is configured to control the drive current provided to the UV-LED based at least in part on the UV transmittance of the fluid in the cavity of the fluid container.
39. An ultraviolet disinfectant head according to aspect 1 comprising heat sink in thermal contact with the UV-LED for cooling of the UV-LED.
40. A method for treating fluid contained in a cavity of a fluid container having a central axis, the method comprising:
   attaching an ultraviolet disinfectant head to the fluid container, the ultraviolet disinfectant head comprising an ultraviolet light emitting diode (UV-LED) having a principal emission axis and a lens having a primary optical axis;
   emitting radiation from the UV-LED; and
   refracting the radiation through the lens to direct refracted radiation toward the cavity of the fluid container.
41. A method according to aspect 40 wherein the lens is a diverging lens.
42. A method according to aspect 40 wherein the refracted radiation is diverging when it reaches a fill plane of the fluid container
43. A method according to aspect 40 wherein when the ultraviolet disinfectant head is attached to the fluid container:
   the principal emission axis of the UV-LED is co-axial with the central axis of the fluid container; and
   the principal emission axis of the UV-LED is co-axial with the primary optical axis of the lens.
44. A method according to aspect 40 wherein the principal emission axis of the UV-LED is spaced apart from and parallel to the central axis of the fluid container when the ultraviolet disinfectant head is attached to the fluid container.
45. A method according to aspect 44 wherein the principal emission axis of the UV-LED is co-axial to the primary optical axis of the lens.
46. A method according to aspect 44 wherein the principal emission axis of the UV-LED is spaced apart from and parallel to the primary optical axis of the lens.
47. A method according to any one of aspect 44 wherein the principal emission axis of the UV-LED is oriented at a first angle relative to the primary optical axis of the lens and the first angle is an acute angle.
48. A method according to aspect 40 wherein the UV-LED is spaced apart from the central axis of the fluid container and the principal emission axis of the UV-LED is non-parallel to the central axis of the fluid container when the ultraviolet disinfectant head is attached to the fluid container.
49. A method according to aspect 48 wherein the principal emission axis of the UV-LED is co-axial to the primary optical axis of the lens.
50. A method according to aspect 48 wherein the principal emission axis of the UV-LED is spaced apart from and parallel to the primary optical axis of the lens.
51. A method according to aspect 48 wherein the primary optical axis of the lens is spaced apart from and parallel to the central axis of the fluid container.
52. A method according to aspect 43 wherein the principal emission axis of the UV-LED is oriented at a second angle relative to the primary optical axis of the lens and the second angle is an acute angle.
53. A method according to aspect 40 wherein the UV-LED is spaced apart from the central axis of the fluid container and the principal emission axis of the UV-LED is oriented at a third angle relative to the central axis of the fluid container when the ultraviolet disinfectant head is attached to the fluid container and the third angle is an acute angle.
54. A method according to aspect 53 wherein the principal emission axis of the UV-LED is co-axial to the primary optical axis of the lens.
55. A method according to aspect 53 wherein the principal emission axis of the UV-LED is spaced apart from and parallel to the primary optical axis of the lens.
56. A method according to aspect 53 wherein the primary optical axis of the lens is spaced apart from and parallel to the central axis of the fluid container.
57. A method according to aspect 53 wherein the principal emission axis of the UV-LED is oriented at a fourth angle relative to the primary optical axis of the lens and the fourth angle is an acute angle.
58. A method according to aspect 40 comprising a filter for filtering fluid that passes through the ultraviolet disinfectant head into or out of the fluid container.
59. A method according to aspect 48 wherein the central axis of the fluid container intersects the filter when the ultraviolet disinfectant head is attached to the fluid container.
60. A method according to aspect 40 wherein the ultraviolet disinfectant head is part of a lid of the fluid container.
61. A method according to aspect 40 wherein the ultraviolet disinfectant head is attachable to a mouth of the fluid container.
62. A method according to aspect 40 wherein the ultraviolet disinfectant head is attachable to the fluid container between a mouth of the fluid container and a lid of the fluid container.
63. A method according to aspect 40 wherein the lens is an asymmetric diverging lens.
64. A method according to aspect 40 wherein the lens is an asymmetric diverging lens wherein the asymmetric diverging lens is asymmetric about a central axis of the asymmetric diverging lens.
65. A method according to aspect 40 wherein the lens is a concave lens.
66. A method according to aspect 40 wherein the lens is a biconcave lens.
67. A method according to aspect 40 wherein the lens is a plano-concave lens.
68. A method according to aspect 40 wherein the lens is a negative meniscus lens.
69. A method according to aspect 40 wherein the ultraviolet disinfectant head comprises a second UV-LED and the lens is oriented and/or located to receive second radiation from the second UV-LED and direct second refracted radiation toward the cavity of the fluid container.
70. A method according to aspect 40 wherein the ultraviolet disinfectant head comprises a second lens and the lens and the second lens are together oriented and/or located to receive the radiation from the UV-LED and direct the refracted radiation toward the cavity of the fluid container.
71. A method according to aspect 40 comprising controlling a drive current provided to the UV-LED based at least in part on a temperature of the UV-LED.
72. A method according to aspect 40 comprising controlling a drive current provided to the UV-LED based at least in part on a period of time since the drive current was provided to the UV-LED.
73. A method according to aspect 40 comprising controlling a drive current provided to the UV-LED based at least in part on a level of fluid within the cavity of the fluid container.
74. A method according to aspect 40 comprising controlling a drive current provided to the UV-LED based at least in part on a rate at which fluid is entering the cavity of the fluid container.
75. A method according to aspect 40 comprising controlling a drive current provided to the UV-LED based at least in part on a UV transmittance of the fluid in the cavity of the fluid container.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. An ultraviolet disinfectant head for disinfecting a fluid housed in a cavity of a fluid container having a central axis, the ultraviolet disinfectant head comprising:
an ultraviolet light emitting diode (UV-LED) having a principal emission axis; and
a lens having a primary optical axis, the lens oriented and/or located to receive radiation from the UV-LED and direct refracted radiation toward a fill plane of the cavity of the fluid container.

2. An ultraviolet disinfectant head according to claim 1 wherein the lens is a diverging lens.

3. An ultraviolet disinfectant head according to claim 1 wherein that the refracted radiation is diverging when it reaches the fill plane of the fluid container.

4. An ultraviolet disinfectant head according to claim 1 wherein when the ultraviolet disinfectant head is attached to the fluid container:
the principal emission axis of the UV-LED is co-axial with the central axis of the fluid container; and
the principal emission axis of the UV-LED is co-axial with the primary optical axis of the lens.

5. An ultraviolet disinfectant head according to claim 1 wherein the principal emission axis of the UV-LED is spaced apart from and parallel to the central axis of the fluid container when the ultraviolet disinfectant head is attached to the fluid container.

6. An ultraviolet disinfectant head according to claim 5 wherein the principal emission axis of the UV-LED is co-axial to the primary optical axis of the lens.

7. An ultraviolet disinfectant head according to claim 5 wherein the principal emission axis of the UV-LED is spaced apart from and parallel to the primary optical axis of the lens.

8. An ultraviolet disinfectant head according to any one of claim 5 wherein the principal emission axis of the UV-LED is oriented at a first angle relative to the primary optical axis of the lens and the first angle is an acute angle.

9. An ultraviolet disinfectant head according to claim 1 wherein the UV-LED is spaced apart from the central axis of the fluid container and the principal emission axis of the UV-LED is non-parallel to the central axis of the fluid container when the ultraviolet disinfectant head is attached to the fluid container.

10. An ultraviolet disinfectant head according to claim 9 wherein the principal emission axis of the UV-LED is co-axial to the primary optical axis of the lens.

11. An ultraviolet disinfectant head according to claim 9 wherein the principal emission axis of the UV-LED is spaced apart from and parallel to the primary optical axis of the lens.

12. An ultraviolet disinfectant head according to claim 9 wherein the primary optical axis of the lens is spaced apart from and parallel to the central axis of the fluid container.

13. An ultraviolet disinfectant head according to claim 9 wherein the principal emission axis of the UV-LED is oriented at a second angle relative to the primary optical axis of the lens and the second angle is an acute angle.

14. An ultraviolet disinfectant head according to claim 1 wherein the UV-LED is spaced apart from the central axis of the fluid container and the principal emission axis of the UV-LED is oriented at a third angle relative to the central axis of the fluid container when the ultraviolet disinfectant head is attached to the fluid container and the third angle is an acute angle.

15. An ultraviolet disinfectant head according to claim 14 wherein the principal emission axis of the UV-LED is co-axial to the primary optical axis of the lens.

16. An ultraviolet disinfectant head according to claim 14 wherein the principal emission axis of the UV-LED is spaced apart from and parallel to the primary optical axis of the lens.

17. An ultraviolet disinfectant head according to claim 14 wherein the primary optical axis of the lens is spaced apart from and parallel to the central axis of the fluid container.

18. An ultraviolet disinfectant head according to claim 14 wherein the principal emission axis of the UV-LED is oriented at a fourth angle relative to the primary optical axis of the lens and the fourth angle is an acute angle.

19. An ultraviolet disinfectant head according to claim 1 comprising a filter for filtering fluid that passes through the ultraviolet disinfectant head into or out of the fluid container.

20. An ultraviolet disinfectant head according to claim 19 wherein the central axis of the fluid container intersects the filter when the ultraviolet disinfectant head is attached to the fluid container.
